(19) United States
(12) Patent Application Publication
(10) Pub. No.: US 2006/0193313 A1
(43) Pub. Date: Aug. 31, 2006

(54) Local area network above telephony infrastructure

(75) Inventors: James F. Landry, Germantown, MD (US); Andrew Pozsgay, Germantown, MD (US)

Correspondence Address: VOLENTINE FRANCOS, & WHITT PLLC, ONE FREEDOM SQUARE, 11951 FREEDOM DRIVE SUITE 1260, RESTON, VA, 20190, US

(73) Assignee: TELKONET, INC.

(21) Appl. No.: 11/064,851

(22) Filed: Feb. 25, 2005

(51) Int. Cl. H04L 12/50; H04Q 11/00

(52) U.S. Cl. 370/365

(57) ABSTRACT

A method and apparatus for modifying a telephone network to create a local area network over telephony (LAN/T) communication system network is disclosed. By coupling a broadband communication gateway and one or more client access devices to a wired telephone network, the telephone network can act as a LAN without interfering with ongoing telephony traffic.

### FIELD OF THE INVENTION

The methods and systems of this disclosure relate to adapting telephone infrastructures to carry both telephonic and non-telephonic communication signals.

### BACKGROUND OF THE INVENTION

The ability to interconnect computers and other intelligent devices is a common requirement wherever people live and work today. The electrical connection required to form many local area network (LAN) communication systems has traditionally been accomplished by installing dedicated data wiring both inside buildings and between clusters of buildings. A number of wireless (i.e. radio) methods have also been developed and deployed to address this need.

More recently, a power-wire based technology was developed to allow electric power wiring infrastructure to simultaneously transport electrical power and high-speed data. This technology, known as “Power Line Carrier” (PLC) technology, typically uses Orthogonal Frequency Division Modulated (OFDM) signals between 2 MHz and 30 MHz injected onto power wiring to transport data.

Power Line Carrier technology offers a number of significant practical advantage over available LAN-based technologies. For example, a PLC-based LAN can be installed in a house or other building without installing a single in-wall wire. Further, PLC-based LANS can cover a greater area than available wireless LANS. Unfortunately, existing PLC-based LANs have a limited data bandwidth and are subject to interference by every appliance and device drawing power from the LANs power lines. Accordingly, new methods and systems capable of providing in-building LANs are desirable.

### SUMMARY OF THE INVENTION

In one aspect, a device for implementing a shared communication system over a wired telephone network installed in a building includes a communication gateway and a coupling device coupled to the communication gateway and configure to be coupled to at least a portion of the wired telephone network, wherein the communication gateway is configured to transmit and receive first communication signals to/from the wired telephony network via the coupling device, the first communication signals being in a frequency band above a frequency band containing telephony traffic on the wired network; and wherein the first communication signals use a LAN protocol.

In a second aspect, a device for implementing a shared communication system over a wired telephone network installed in a building includes a broadband communication device coupled to the wired network and configured to transmit and receive first communication signals to/from the wired telephony network via a coupling device, the first communication signals being in a frequency band above a frequency band containing telephony traffic on the wired network, wherein the first communication signals use a LAN protocol.

In a third aspect, a method for communicating over a wired telephony network includes transmitting a broadband communication signal having embedded information onto the wired-telephony network, the embedded information being derived from a signal provided by an Internet Service Provider (ISP), wherein the broadband communication signal is compliant with a local area network protocol.

In a fourth aspect, a Local Area Network (LAN) includes a plurality of high-frequency broadband communication devices, wherein each communication device is coupled to a twisted-wire-pair, wherein the twisted-wire-pair is capable of carrying a separate low-frequency telephonic signal; and wherein the broadband communication devices communicate using a local area network protocol without interfering with low-frequency telephonic signals.

In a fifth aspect, a communication system includes a first Local Area Network above telephony (LAN/T) network, and a coupling means for coupling the LAN/T to a second local area network.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts the spectra used by many telephone and broadband WAN technologies.

FIG. 2 depicts the spectra used by a HomePlug LAN above telephony network.

FIG. 3 depicts the spectra used by a HomePlug LAN above ADSL WAN above telephony network.

FIG. 4 depicts the spectra used by a HomePlug LAN above VDSL WAN above telephony network.

FIG. 5 depicts an exemplary LAN imposed on a telephony network.

FIG. 6 is an exemplary coupler for the network of FIG. 5.

FIG. 7 is an exemplary an exemplary client access point for the network of FIG. 5.

FIG. 8 is a flowchart outlining an exemplary method for communicating over a LAN above telephony network.

FIG. 9 depicts an exemplary network with component placement for the disclosed devices and methods.

FIG. 10 depicts a second exemplary network with component placement for the disclosed devices and methods.

FIG. 11 depicts a third exemplary network with component placement for the disclosed devices and methods.

FIG. 12 depicts an exemplary LAN over telephone network working in tandem with a powerline communication network.

FIG. 13 depicts a second exemplary LAN over telephone network working in tandem with a powerline communication network.

FIG. 14 depicts a third exemplary LAN over telephone network working in tandem with a powerline communication network.

FIG. 15 depicts a fourth exemplary LAN over telephone network working in tandem with a powerline communication network.

FIG. 16 depicts a fifth exemplary LAN over telephone network working in tandem with a powerline communication network.

FIG. 17 is a flowchart outlining an exemplary method for communicating between a LAN above telephony network and a second network.

### DETAILED DESCRIPTION

Current technologies available to homeowners to create Local Area Networks (LANs) include various wireless technologies, such as Bluetooth and 802.11b networks, and Power Line Communication (PLC) networks, such as those provided by the HomePlug® standards. Unfortunately, both technologies have limited bandwidth, which can prove problematic in high-density housing and office settings.

However, most buildings that have electrical wiring also have telephone wires installed that might also be used to provide LAN services. While the standards-making bodies of the International Telecommunications Union (the “ITU-T”) have promulgated a number of broadband standards, such as Asymmetric Digital Subscribe's Line above Plain Old Telephone Service (ADSL above POTS), these standards were developed for point-to-point communication/Wide Area Network (WAN) systems where that have traditionally been developed with sending and receiving data over long distances.

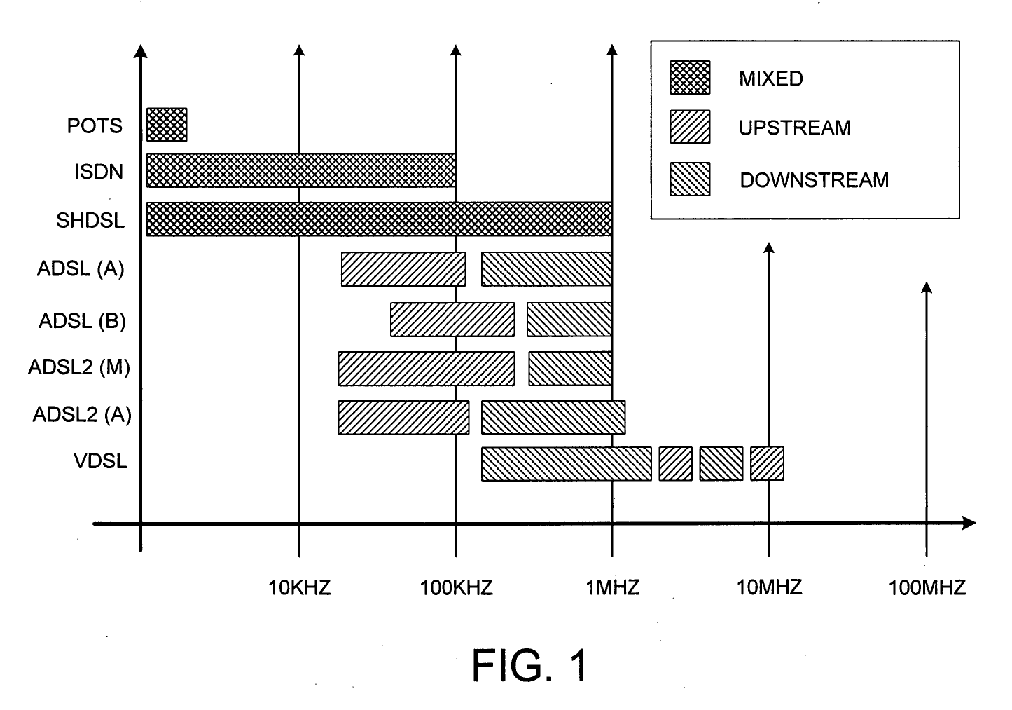

FIG. 1 depicts the bandwidths of various telephony standards, including POTS and Integrated Services Digital Network (ISDN), as well as a number of Digital Subscriber's Loop (DSL) technologies including Symmetric High-bitrate DSL (SHDSL), various Asymmetric DSL (ADSL) standards and Very high-speed DSL (VDSL). Given that the telephony standards require modest bandwidth, standards like ADSL above POTS and ADSL above ISDN have proven useful for their intended purposes, i.e., utilizing existing telephony twisted-wire-pairs for broadband communications.

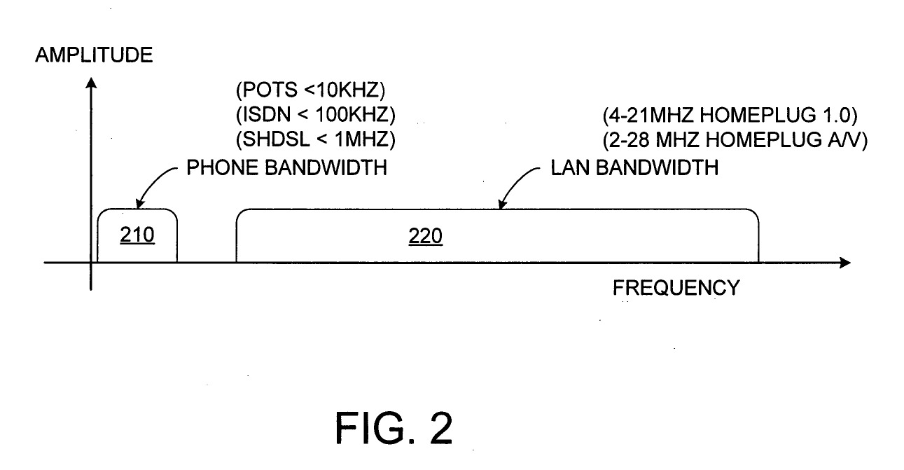

However, there is an existing broadband standard, known as HomePlug®, as well as a large number of viable variants, capable of providing LAN services over powerlines. Accordingly, it should be appreciated that such broadband LAN technology might be applied to creating LANs over telephony lines. FIG. 2 depicts the spectra of a LAN above Telephony (LAN/T) network using either the HomePlug 1.0 standard or the HomePlug A/V standard. That is, as shown in FIG. 2, a LAN spectra 220 can co-exist with a baseband, e.g., telephony, spectra 210, such as POTS, ISDN and even SHDSL, which can simultaneously carry both telephony and other data.

While FIG. 2 was formed with the HomePlug standards in mind, it should be appreciated that any number of broadband LAN standards might be promulgated in order to provide LAN/T services. However, in order to be most effective, however, such standards might desirably include the following attributes:

(A) Specific-frequency point-to-multipoint capability, which refers to the capability that a first device can simultaneously communicate with multiple other devices on a LAN using a each of one or more carrier frequencies. Contrast this capability with the various DSL standards, which generally allow only point-to-point communication. While some DSL standards are partially point-to-multipoint from the standpoint that an upstream device can simultaneously communicate with multiple downstream devices, such communication is limited in that the upstream device maintains communication with each downstream device using separate carrier frequencies in a Discrete Multi-Tone (DMT) environment.

(B) Digital encryption, such as the Digital Encryption Standard (DES) or triple Digital Encryption Standard (3DES or DES3). Presently, DSL and other known WAN standards do not use or need such capability.

(C) An Orthogonal Frequency Division Multiplexing (OFDM) format, which helps to increase bandwidth while decreasing the effects of multi-path signal distortion. While various DSL protocols use a variant of OFDM, i.e., a DMT format, OFDM has a number of advantages over DMT, such as the need for but a single modem.

(D) A contention protocol, such as Carrier Sense Multiple Access/Collision Detection (CSMA/CD), Carrier Sense Multiple Access/Collision Avoidance (CSMA/CA) and Token Passing. The CSMA/CD is a popular protocol that is both fast and commonly used. While the CSMA/CA protocol is not as fast as the CSMA/CD protocol, CSMA/CA has an advantage in that it provides for the “hidden node” problem. The hidden node problem occurs in a point-to-multipoint network and occurs in networks where at least three nodes, Node A, Node B and Node C, are present. It is possible that in certain cases Node B can hear Node A (and vice versa) and Node B can hear Node C (and vice versa) but Node C cannot hear Node A. That is, Nodes A and C are effectively hidden from one another. In such an environment both Node A and Node C could both properly transmit a packet simultaneously in a CSMA/CD environment since they cannot hear each other on a ‘listen’ phase, but the result is that Node B would get corrupted data. However, unlike a CSMA/CD protocol, a CSMA/CA protocol could prevent Nodes A and C from simultaneous transmission with resulting data corruption.

(E) Full spectral bi-directionality, which for the purpose of this disclosure means that almost any device coupled to a network can both receive and transmit information using all or substantially all of an available communication bandwidth. For example, the POTS, ISDN and SHDSL technologies shown in FIG. 1 have full spectral bi-directionality in that their entire useable bandwidth can be used for both transmission and reception. In contrast, the ADSL and VDSL standards allocate separate spectra for separate upstream and downstream data transmission.

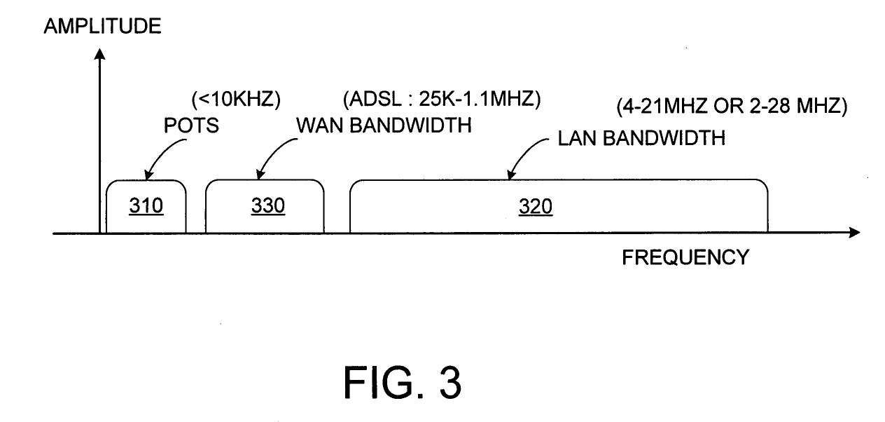

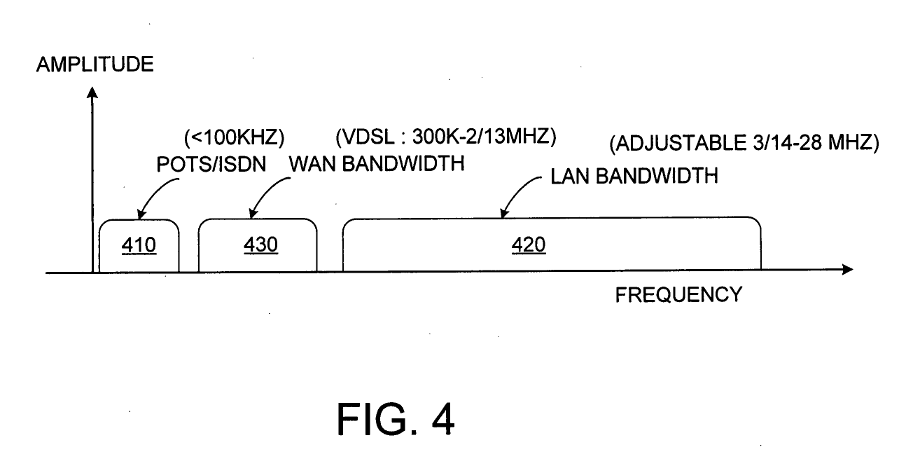

Continuing to FIG. 3, a spectral map of a LAN above WAN above Telephony (LAN/WAN/T) communication system is shown indicating the viability of a twisted-wire-pair can carry a POTS telephony signal 310, an ADSL WAN signal 330 and a HomePlug LAN signal 320. Continuing to FIG. 4, a second LAN/WAN/T spectral map is shown having a POTS (or ISDN) telephony signal 410, a VDSL WAN signal 430 and a HomePlug LAN signal 420. As the VDSL standard uses varied amounts of bandwidth, and known HomePlug modems can be programmed to use or ignore specific frequencies, it should be appreciated that it is possible to allocate LAN and WAN bandwidth based on the needs of a specific communication system without LAN-WAN interference.

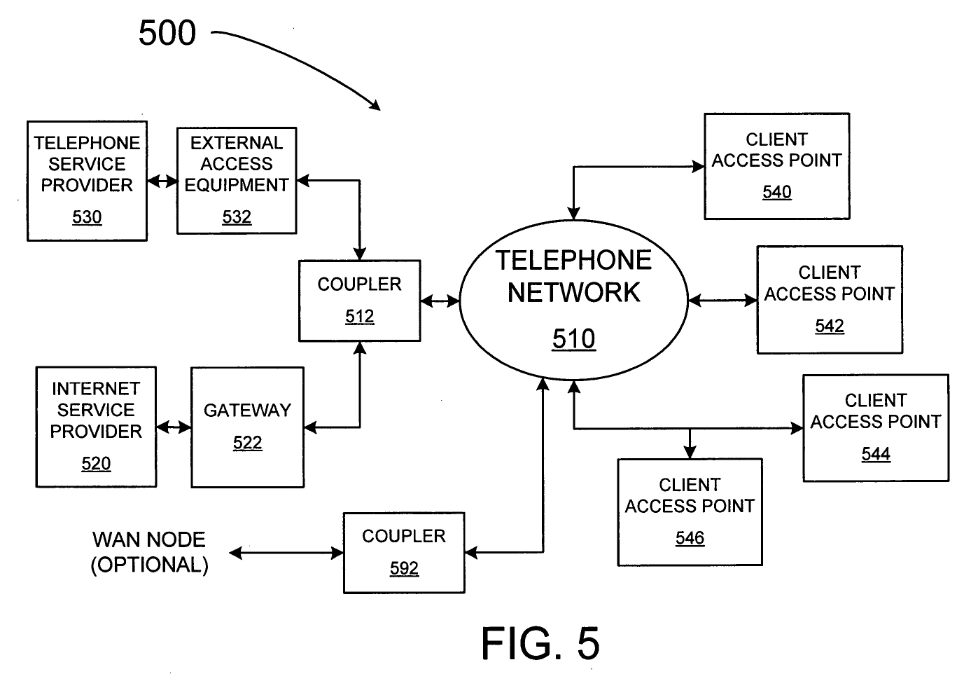

FIG. 5 depicts an exemplary communication system 500 wherein a LAN is imposed on a telephony network. As shown in FIG. 5, the communication system 500 includes a telephony network 510 coupled to a telephone service provider 530 via some external access equipment 532 and a coupler 512. The telephony network 510 is also coupled to an internet service provider (ISP) 520 via a gateway 522 and coupler 512. Still further, the telephony network 510 is coupled to a number of client access points 540-546 and an optional external WAN node (not pictured) via a WAN coupler 592.

In operation, the telephone network 510 can be used to transport telephony signals (or other baseband signals, such as SHDSL) between various telephones, facsimile machines, modems or telephony equipment located at the client access points 540-546 and the telephone service provider 530, or possibly used to transport telephony signals client access points 540-546. When a client access point 540-546 is in communication with the telephone service provider 530, the telephony signals would, of course, be relayed/transmitted/received via the external access equipment 532 and coupler 512

Simultaneously, the telephone network 510 can be used to transport various broadband signals, such as HomePlug compatible or other LAN signals both between client access points 540-546 and to/from individual between client access points 540-546 and an external device or system, e.g., a specific communication node on the ISP 520. When a client access point 540-546 is in communication with the ISP 520, the broadband signals would, of course, be relayed/transmitted/received via the gateway 522 and coupler 512.

As discussed above with reference to FIGS. 3 and 4, in addition to the telephony and LAN signals the telephony network might also be used to convey WAN signals to and from an external WAN node via the WAN coupler 592.

The exemplary telephony network 510 consists of one or more pairs of twisted-wire-pairs commonly used for telephony purposes. However, it should be appreciated that the particular physical makeup of the telephone network 510 can take any combination of forms, such as electrically conducting wire-pairs, twisted-wire-pairs or cable, wireless forms, optical forms, sonic forms etc. It should also be appreciated that, when the telephone network 510 takes certain electrically conducting forms, such forms may consist a single length of twisted-wire-pair, a number of twisted-wire pairs connected together such that they have common TIP and RING nodes or may consist of numerous separate TIP/RING nodes capable of carrying separate telephony signals.

The external access equipment 532 of the present example of FIG. 5 is a POTS-based interface. However, the external access equipment 532 can also take the form of a Private Branch eXchange (PBX) system, a Private Automated Branch eXchange (PABX) system or any other known or later developed form of telephony equipment capable of linking telephony equipment with a telephony service provider (or possibly interlinking telephony equipment) without departing from the spirit and scope of the present disclosure.

The gateway 522 of the present example of FIG. 5 is any of a number of HomePlug-based gateways capable of interconnecting a computer-based device coupled to network 510 with an ISP or other external data node. However, in variants not using HomePlug technology, the gateway 522 is envisioned to take any suitable form capable of linking various computer-based devices with an ISP or other external data node (or possibly interlinking such devices) without departing from the spirit and scope of the present disclosure.

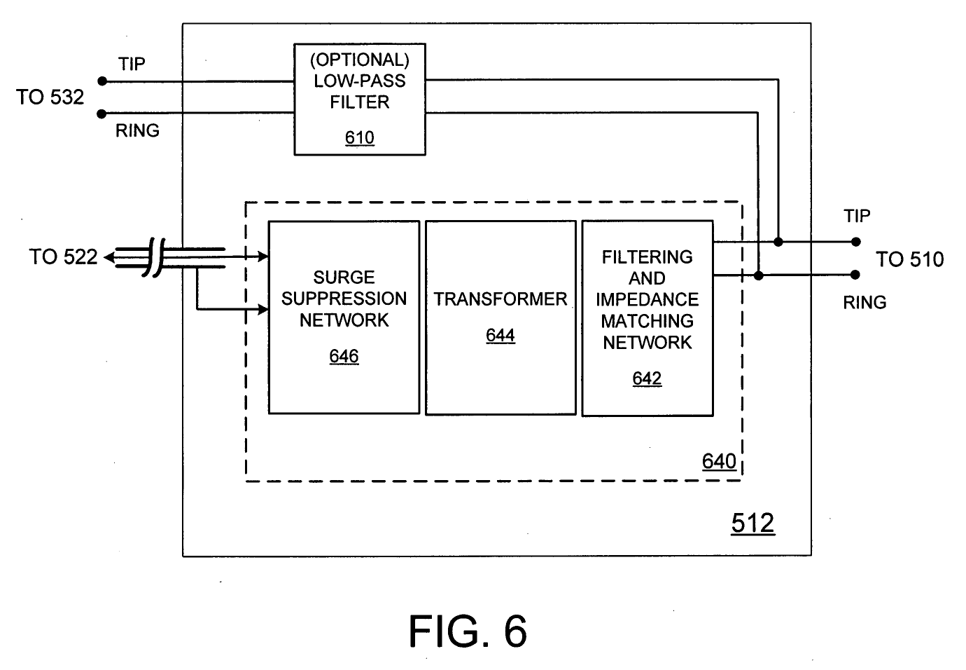

FIG. 6 depicts an exemplary coupler 512 capable of linking both a baseband telephony device and a broadband communication device to a common network, such as the telephony network depicted in FIG. 5. As shown in FIG. 6, the coupler 512 includes a low-pass-filter 610 and a data coupler 640. The data coupler 640 includes a filtering and impedance matching network 542, a transformer 544 and a surge suppression network 546. The filtering and impedance matching network 542 is used to appropriately match the characteristics of a gateway to a telephony network; the transformer 544 is used to provide for electrical isolation and to eliminate low-frequency signals; and the surge suppression network 546 is used to prevent high-voltage spikes that may appear on a particular telephony network from damaging a gateway (or other equipment), prevent human injury and to generally to conform to any applicable regulations or mandates.

In operation, the low-pass-filter 610, which may be optional in certain situations (e.g., depending on telephony equipment used), can be used to block out high-frequency signals, but to otherwise leave the telephony signals typically found on Tip-Ring pairs (such as voice and POTS signaling) unaltered. Thus, the TIP-RING pair on both the right-hand and left-hand sides of FIG. 6 should essentially appear as the same POTS or ISDN (or possibly SHDSL) nodes.

The data coupler 640, which complements the low-pass-filter 610, can essentially provide many of the same functions for higher-frequency signals, i.e., filters out undesirable low-frequency signals while coupling desirable signals. However, as mentioned above the data coupler 640 can also provide surge protection and provide impedance matching to improve system performance.

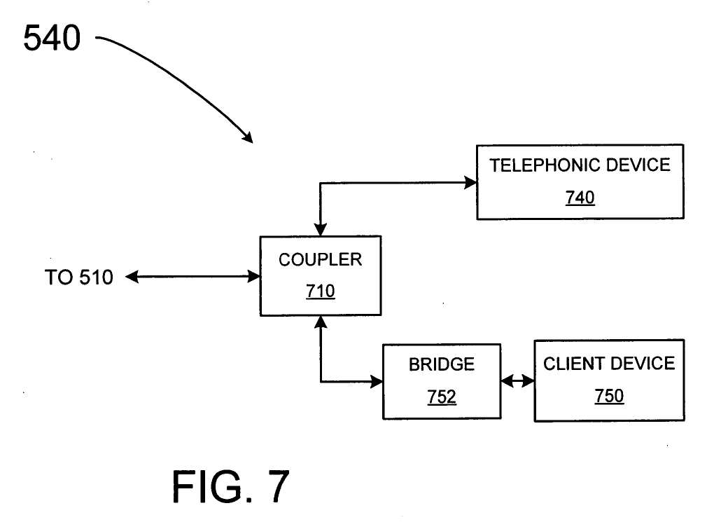

FIG. 7 depicts an exemplary client access point 540 according to the present disclosure. As shown in FIG. 7, the exemplary client access point 540 includes a client coupler 710, a telephonic device 740, a client bridge and a client device 750.

In operation, the telephonic device 740, which can be any combination of telephone-based devices such as telephones, facsimiles, modems etc, can transmit signals to and receive signals from a wired network, such as the telephone network shown in FIG. 5, via the client coupler 710.

Similarly, the client device 750, which can be almost any computer-based device capable of transmitting and receiving data, can transmit signals to and receive signals from a wired network, such as the telephone network shown in FIG. 5, via the client coupler 714 and client bridge 752.

The client coupler 710 of the present embodiment is similar to the coupler of FIG. 6 and can have both a low-pass-filtering portion to isolate high-frequency signals from the telephonic device 740 and a data coupling portion effectively couple broadband data signals between a network and the client bridge 752. However, it is envisioned that the exact makeup and architecture of the client coupler 710 may change based on the particular nature of the telephony and broadband signal, or possible change to accommodate client access points that only require telephony services or only require data services.

For example, if a particular client access point included a simple POTS telephone, a high-frequency data coupler would not be necessary. Similarly, a client access point having no telephone would require no low-pass filtering.

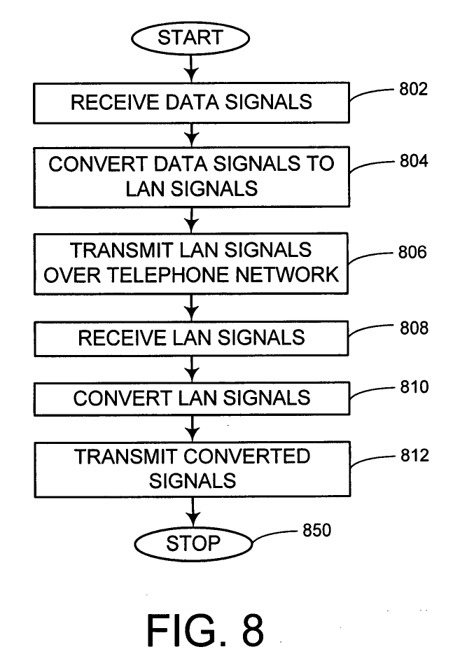

FIG. 8 is a flowchart outlining an exemplary method for communicating over a LAN above telephony network. The method starts in step 802 where one or more data signals are received from an external device, such as an ISP or a particular computer-based device, by a gateway, bridge or other suitable device. Next, in step 804, the data signals are effectively converted to a broadband LAN signal, such as the various LAN signals discussed above by the gateway or bridge. Then, in step 806, the LAN signals are transmitted over a telephony network, such as any of those discussed above, by the gateway or bridge. As discussed above, the exemplary LAN signals can have any combination of the LAN traits, e.g., DES encryption, discussed above, but it should be appreciated that the particular traits employed in a particular embodiment can vary as required or otherwise desired from one embodiment to the next. Control continues to step 808.

In step 808, the transmitted LAN signals are then received by a gateway, bridge or other suitable device. Next, in step 810, the LAN signals are converted to an appropriate format, e.g., 10baseT or Ethernet, so that they might be conveyed to a receiving device, e.g., an ISP or computer. Then, in step 812, the converted signals are transmitted to an intended recipient. Control then continues to step 850 where the process stops.

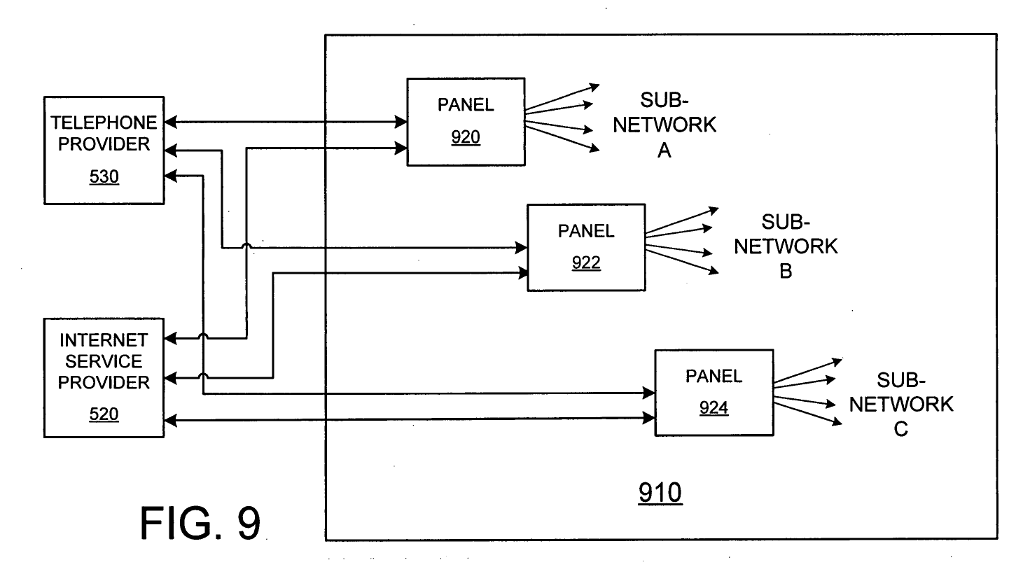

FIG. 9 depicts an exemplary LAN/T network located in a single building 910 with separate and having a number of independent and electrically isolated telephony sub-networks A, B and C, which can be accessible by respective panels (equipment centers) 920, 922 and 924 also located within the building 910. The exemplary panels 920, 922 and 924 of the exemplary embodiment can be accessed by a common telephone provider 530 and common ISP 520, but in other embodiments can be accessed by different telephony and internet providers. In certain circumstances, the existence of electrically isolated and independent sub-networks can provide a boon as a single gateway (potentially located at each 920, 922 and 924) can have a lower number of clients to serve, thus increasing the available bandwidth per client.

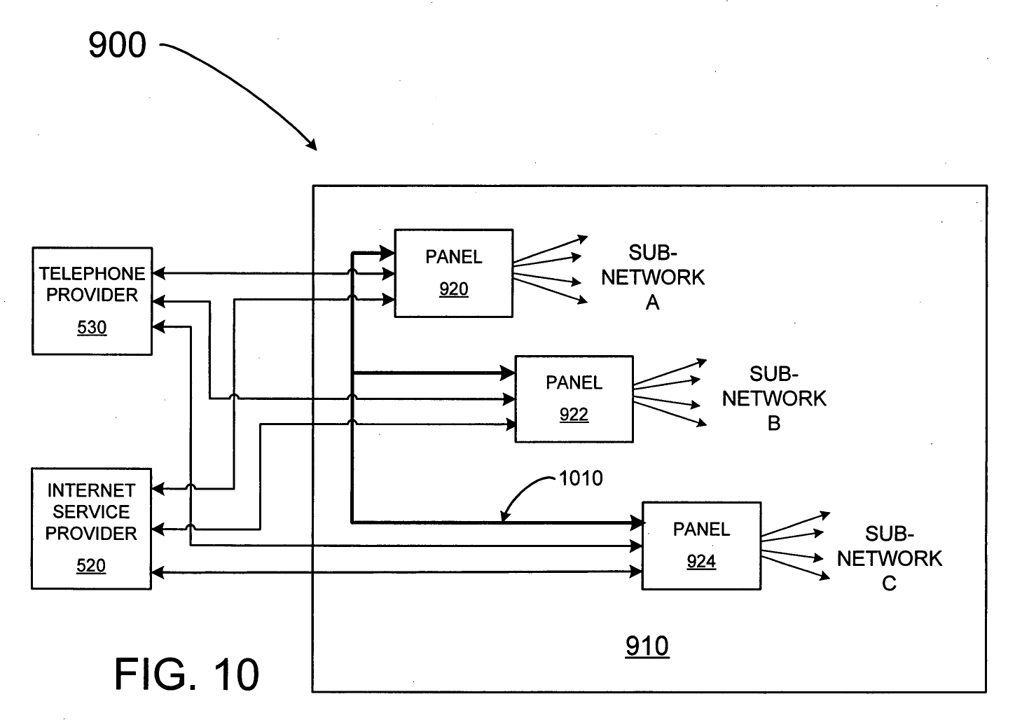

However, in certain circumstances where a substantial connectivity between two sub-networks is required, the isolation depicted in FIG. 9 poses a disadvantage. FIG. 10 depicts a second exemplary network similar to that of FIG. 9 but with a common network line 1010 running between the panels 920, 922 and 924. The common network line 1010 of the exemplary embodiment is an Ethernet-based line using dedicated wiring and is connected to gateways capable of converting signals between LAN/T and Ethernet formats. However, it should be appreciated that the form of the common network line 1010 can vary to any number of known technologies to include a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

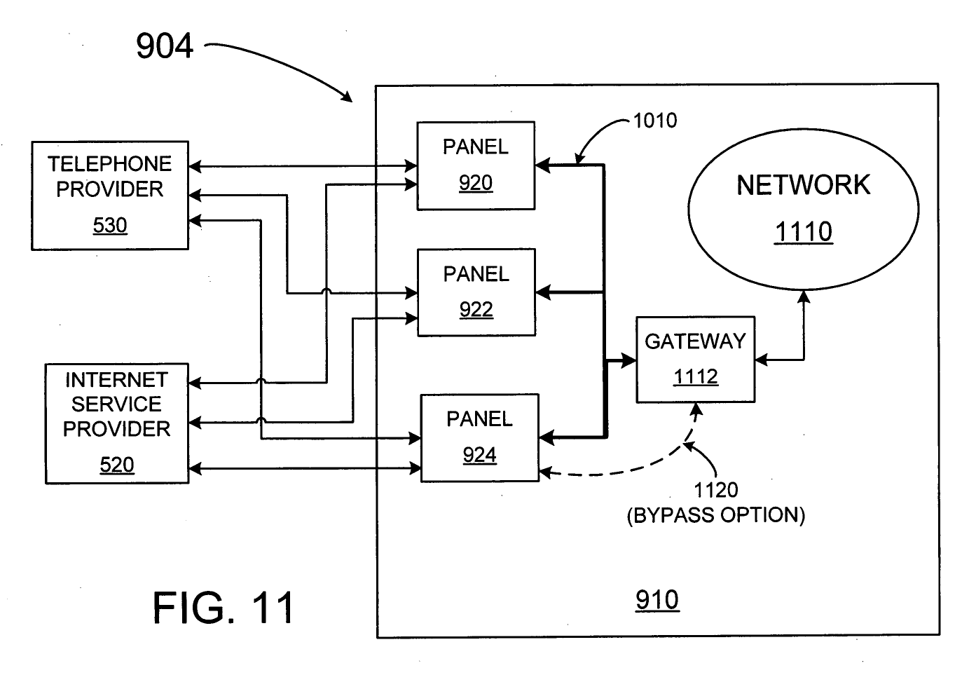

FIG. 11 depicts a third exemplary network similar to that of FIG. 10 but including a separate network 1110, e.g., an Ethernet-based LAN, accessible via a gateway 1112. Isolated networks such as that depicted in FIG. 11 may arise in situations where portions of a building can be wired for a dedicated LAN, but the nature of the building as a whole precludes easy access of the LAN to an ISP or computer nodes located elsewhere in the building. The solution provided by FIG. 11 may provide an inexpensive and effective connectivity alternative to other technologies. Further, by altering gateway 1112 to receive WAN signals and configuring one of the sub-networks to use a WAN (ADSL or VDSL) above telephony (POTS or ISDN) protocol or to use a LAN/WAN/T protocol discussed above, gateway 1112 can be connected directly to one or all of the sub-networks and receive internet connectivity without disturbing the LAN connectivity of the sub-networks.

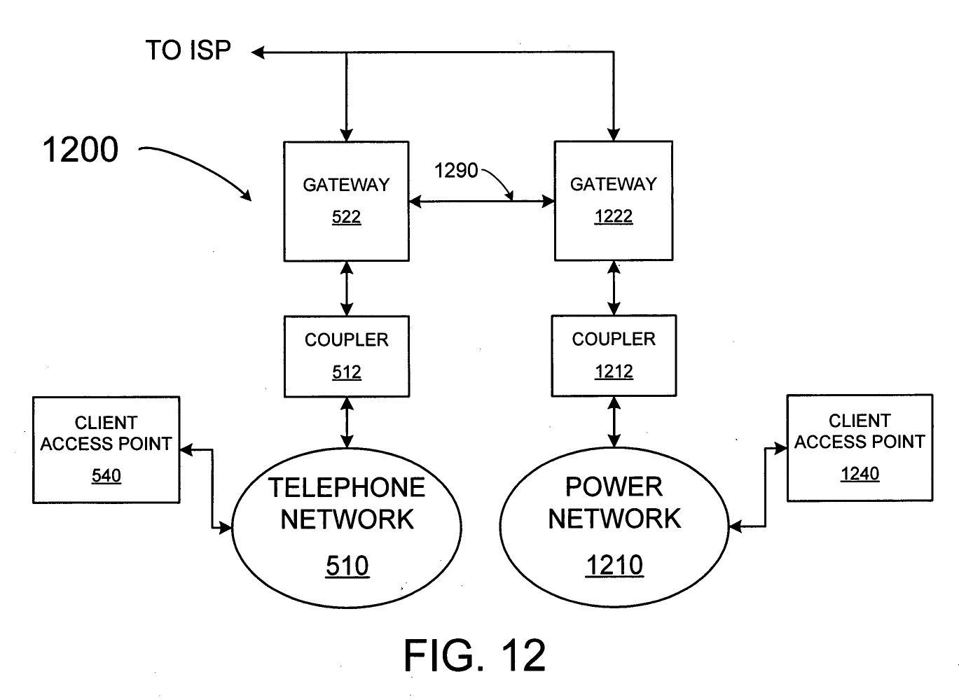

In addition to working in tandem with standard LANs, the exemplary methods and systems can similarly work with PLCs. FIG. 12 depicts an exemplary LAN/T-PLC communication network 1200. As shown in FIG. 12, telephone network 510 can be configured for LAN/T operation using gateway 522 and coupler 512 while power network 1210 can be configured for PLC operation using gateway 1222 and coupler 1212. The two networks 510 and 1210 can be optionally linked via common network line 1290, which can utilize any number of network technologies, thus allowing communication between client access points 540 and 1240.

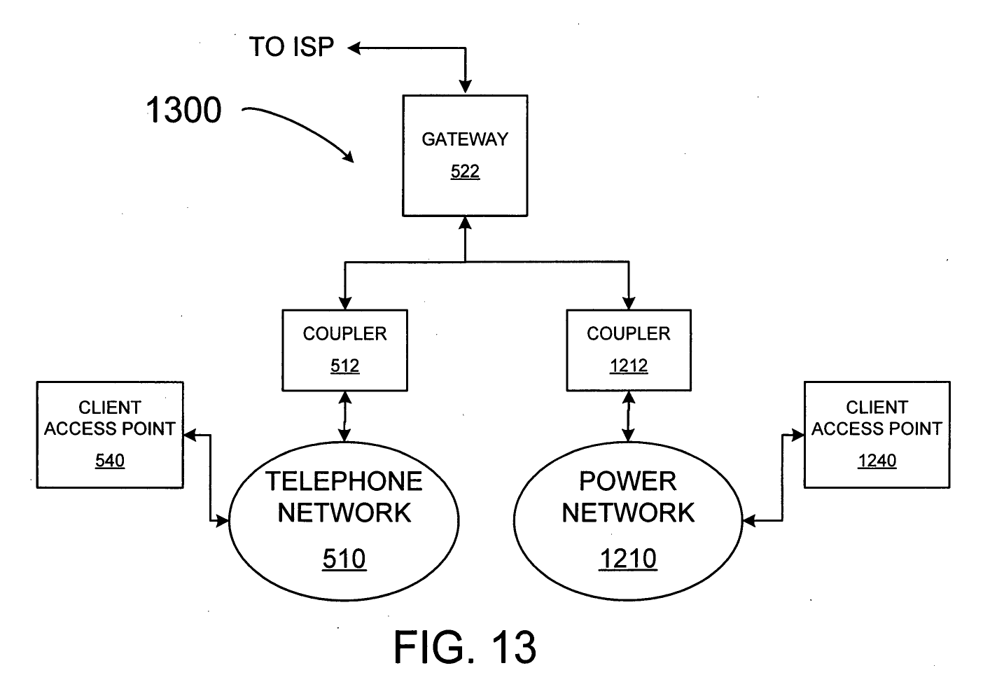

FIG. 13 depicts a network 1300 that is variant of the network of FIG. 12 where both the telephone network 510 and power network 1210 are converted to LAN/T and PLC operation using a common gateway 522. Systems such as that depicted in FIG. 13 can be realized by using a protocol, such as HomePlug, that may be used on both telephony and power line networks. In the network 1300 of FIG. 13, communication between client access point 540 and client access point 1240 may occur directly or may optionally be facilitated using the gateway 522.

For example, in certain situations where client access point 540 and client access point 1240 are not hidden from one another, client access point 540 can send a communication signal to client access point 1240 via the telephone network 510, coupler 512, coupler 1212 and power network 1210.

Return communication signals from client access point 1240 to client access point 540 can follow the reverse route of the power network 1210, coupler 1212, coupler 512 and the telephone network 510.

However, in situations where client access point 540 and client access point 1240 are hidden from one another or distant enough such that direct communication would be slow, gateway 522 may act as a repeater to facilitate communication.

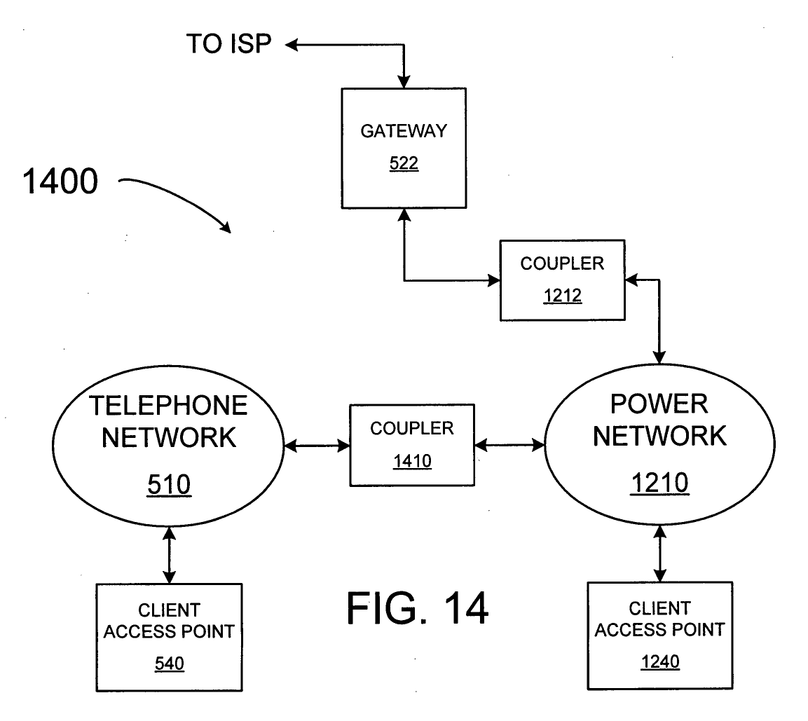

FIG. 14 depicts a network 1400 that is another hybrid of LAN/T and PLC technologies whereby the telephone network 510 and power network 1210 are coupled by a single coupler 1410, and where client access point 540 gains ISP access via both the telephone network 510 and power network 1210. As with the network of FIG. 13, the present network 1400 can be realized using the HomePlug protocol.

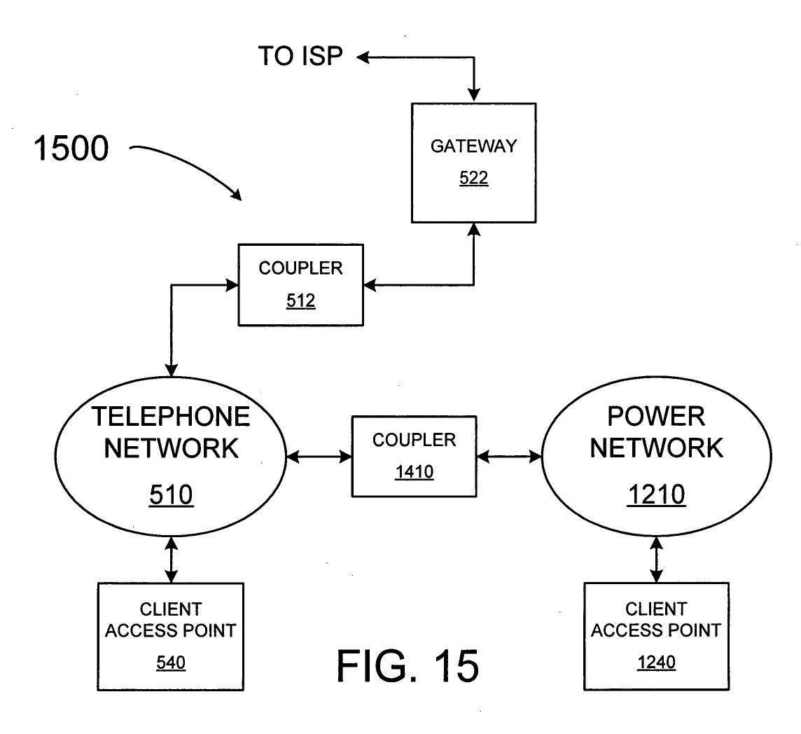

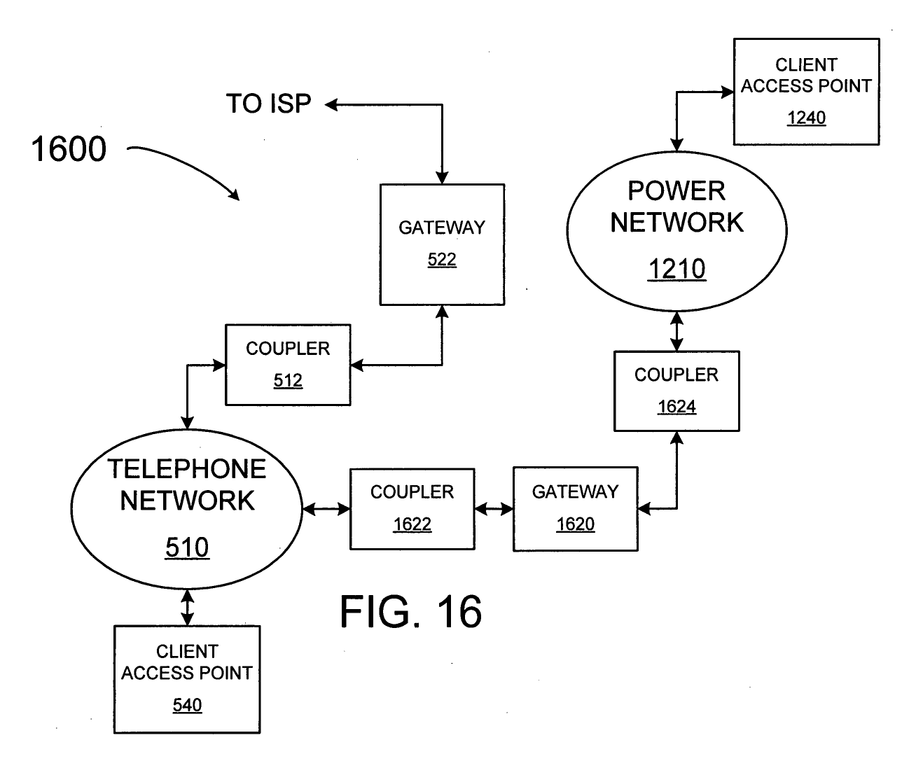

FIG. 15 depicts another network 1500 that is another hybrid of LAN/T and PLC technologies whereby the telephone network 510 and power network 1210 are coupled by a single coupler 1410, and where client access point 1240 gains ISP access via both the telephone network 510 and power network 1210. Again as with the network of FIG. 13, the present network 1500 can be realized using the HomePlug protocol. FIG. 16 depicts yet another network 1600 that is another hybrid of LAN/T and PLC technologies similar to the network of FIG. 15, but wherein coupler 1410 is replaced by a gateway 1620 and couplers 1622 and 1624.

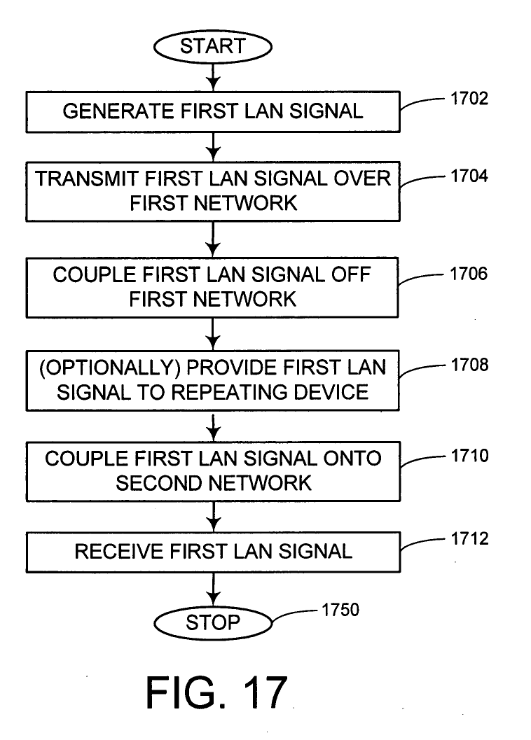

FIG. 17 is a flowchart outlining an exemplary method for communicating between devices on separate networks that include at least one LAN/T network. The process starts in step 1702 wherein a first LAN signal is generated by a computer-based device. Next, in step 1704 the first LAN signal is transmitted over a first LAN. As mentioned above the first LAN can be a LAN/T-based network, or can in other embodiments be from any other form of LAN, such as a PLC LAN, an Ethernet LAN and so on. Then, in step 1706, the first LAN signal is coupled off the first network via any number of coupling devices discussed above. Control continues to step 1708.

In step 1708 wherein a first LAN signal is optionally provided to a repeater, e.g., an appropriately configured gateway, where it is essentially received and retransmitted by the repeater. Next, in step 1710, the first LAN signal (repeated or original) is coupled onto a second network via any number of coupling. As with the first LAN, the second LAN can be a LAN/T-based network, or can in other embodiments be from any other form of LAN, such as a PLC LAN, an Ethernet LAN and so on. Control continues to step 1712.

In step 1712, the first LAN signal is received by a computer-based device coupled to the second network. Control then continues to step 1750 where the process stops.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to communication services.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A device for implementing a shared communication system over a wired telephone network installed in a building, the device comprising:
a communication gateway; and
a coupling device coupled to the communication gateway and configured to be coupled to at least a portion of the wired telephone network;
wherein the communication gateway is configured to transmit and receive first communication signals to/from the wired telephony network via the coupling device, the first communication signals being in a frequency band above a frequency band containing telephony traffic on the wired network; and
wherein the first communication signals use a LAN protocol.

2. The device of claim 1, wherein the first communication signals use an Orthogonal Frequency Division Multiplexed (OFDM) protocol.

3. The device of claim 1, wherein the first communication signals use a collision avoidance protocol.

4. The device of claim 1, wherein the first communication signals use a protocol capable of addressing the hidden node problem.

5. The device of claim 1, wherein the communication gateway is configured to communicate over the wired telephone network using a substantially full spectral bi-directionality protocol.

6. The device of claim 2, wherein the first communication signals comply with the Homeplug 1.0 communication standard.

7. The device of claim 2, wherein the first communication signals are power-adjusted in such a way as to not distress telephony components on the wired network.

8. The device of claim 2, wherein the first communication signals comply with the Homeplug A/V communication standard.

9. The device of claim 1, wherein the communication gateway provides a communication interlink between an external Internet Service Provider (ISP) and at least one computer-based device coupled to the wired telephone network.

10. The device of claim 9, further comprising one or more client access points electrically coupled to the wired network, each access point having a computer-based device capable of communicating with the gateway via the wired network.

11. The device of claim 10, wherein each client access point includes a bridge capable of translating between the LAN protocol of the wired telephony network and a respective computer-based device.

12. The device of claim 10, wherein each client access point includes a coupler capable of receiving telephony signals from a respective telephonic device, receiving LAN signals from a respective bridge, and injecting both the telephony and LAN signals onto the wired network.

13. The device of claim 1, wherein the telephony traffic on the wired network includes Plain Old Telephone Service (POTS)-based signals.

14. The device of claim 1, wherein the telephony traffic on the wired network includes Integrated Services Digital Network (ISDN)-based signals.

15. The device of claim 1, wherein the wired telephone network is one of a Private Branch eXchange (PBX) system or Private Automated Branch eXchange (PABX) system.

16. The device of claim 1, wherein the coupling device includes a low-pass filter electrically placed between the communication gateway and a telephonic external access device, the low-pass filter being configured to substantially isolate LAN communication signals residing on the wired telephone network from the telephonic external access device.

17. A device for implementing a shared communication system over a wired telephone network installed in a building, the device comprising:
a broadband communication device coupled to the wired network and configured to transmit and receive first communication signals to/from the wired telephony network via a coupling device, the first communication signals being in a frequency band above a frequency band containing telephony traffic on the wired network; and
wherein the first communication signals use a LAN protocol, and wherein the first communication signals use an Orthogonal Frequency Division Multiplexed (OFDM) protocol.

18. A method for communicating over a wired telephony network, comprising:
transmitting a broadband communication signal having embedded information onto the wired-telephony network, the embedded information being derived from a signal provided by an Internet Service Provider (ISP);
wherein the broadband communication signal is compliant with a local area network protocol.

19. The method of claim 18, wherein the broadband communication signal is substantially compliant with a Homeplug communication standard.

20. The method of claim 19, further comprising receiving the broadband communication signal via the wired-network, then extracting the embedded information from the broadband communication signal.

21. A Local Area Network (LAN), comprising:
a gateway;
a plurality of high-frequency broadband communication devices in communication with the gateway, wherein each communication device is coupled to a respective twisted-wire-pair, and wherein each twisted-wire-pair is capable of carrying a separate low-frequency telephonic signal; and
wherein the broadband communication devices communicate using a local area network protocol without interfering with low-frequency telephonic signals.

22. The Local Area Network of claim 21, further comprising:
a gateway;
wherein each of the plurality of high-frequency broadband communication devices can communicate with the gateway via its respective twisted-wire-pair.
